(19) United States
(12) Patent Application Publication
(10) Pub. No.: US 2004/0258802 A1
(43) Pub. Date: Dec. 23, 2004

(54) Ingestible supplement for enhancing animal performance

(76) Inventor: A.B. Hudson, Maple Hill, KS (US)

Correspondence Address: HOVEY WILLIAMS LLP, 2405 Grand , Suite 400, Kansas City, MO, 64108, US

(21) Appl. No.: 10/600,321

(22) Filed: Jun. 20, 2003

(51) Int. Cl. A23K 1/175

(52) U.S. Cl. 426/74

(57) ABSTRACT

An ingestible bone meal-containing supplement can be fed to carnivorous animals in order to prevent the animals from grazing on vegetation. The ingestible supplement comprises at least about 5 weight percent bone meal and at least about 25 weight percent of a palatability enhancer. The ingestible supplement contains the bone meal and the palatability enhancer in a bone meal-to-palatability enhancer weight ratio in the range of from about 1:10 to about 1:1.

### BACKGROUND OF THE INVENTION

1. Field of the Invention

The present invention relates generally to ingestible supplements for enhancing the performance of animals. In another aspect, the invention concerns a bone meal-containing supplement that can be fed to carnivorous animals to prevent them from grazing on vegetation.

2. Description of the Prior Art

It is commonly known that carnivorous animals (e.g., dogs and cats) may periodically ingest grass or other vegetation. This behavior of grazing on vegetation can produce a variety of undesirable results. For example, dogs and cats that graze on vegetation tend to regurgitate frequently. Further, because the digestive systems of carnivorous animals are not equipped to handle vegetation, such vegetation can cause blockage in the digestive system of the animal. Such digestive system blockage can lead to frequent squatting of the animal (in an effort to defecate) or even death.

Grazing of hunting dogs can be particularly problematic because it can cause them to stop frequently during the hunt, either to graze or attempt defecation. Obviously, the performance of a hunting dog is dramatically decreased by such frequent stops.

### OBJECTS AND SUMMARY OF THE INVENTION

It is, therefore, an object of the present invention to provide an ingestible supplement that can be fed to carnivorous animals to thereby prevent them from grazing on vegetation. Other objects and advantages of the present invention will be apparent from the following detailed description of the preferred embodiment and claims.

Accordingly, in one embodiment of the present invention there is provided an ingestible supplement comprising at least about 5 weight percent bone meal and at least about 25 weight percent of a palatability enhancer that is highly palatable to carnivorous animals. The bone meal and the palatability enhancer are present in the supplement in a bone meal-to-palatability enhancer weight ratio in the range of from about 1:10 to 1:1.

In another embodiment of the present invention, there is provided an ingestible supplement palatable to dogs and cats. The supplement consists essentially of bone meal and a palatability enhancer that is highly palatable to carnivorous animals. The bone meal and the palatability enhancer are present in the supplement in a bone meal-to-palatability enhancer weight in the range of from about 1:5 to about 1:2.

In still another embodiment of the present invention, there is provided a method of preventing a carnivorous animal from grazing on vegetation. The method includes the step of causing the animal to ingest a supplement comprising at least about 5 weight percent bone meal and at least about 25 weight percent of a palatability enhancer that is highly palatable to the carnivorous animal.

### DETAILED DESCRIPTION OF THE PREFERRED EMBODIMENT

In one embodiment of the present invention, there is provided in ingestible supplement that prevents carnivorous animals from grazing on vegetation. This supplement generally comprises bone meal and a palatability enhancer.

Bone meal is a commonly known substance that is produce via grinding the bones of animals into a relatively fine powder. Bone meal has been used in animal food for years as a source of calcium, phosphorus, and other vitamins/minerals that contribute to animal health. One disadvantage, however, of using bone meal in animal food is that the bone meal can cause rapid spoilage of the animal food if used in large amounts and not refrigerated. Thus, heretofore, bone meal has only been used in relatively small quantities in animal foods. This small quantity of bone meal in conventional animal foods has been insufficient to provide any decrease in the tendency of carnivorous animals to graze on vegetation.

The palatability enhancer component of the inventive ingestible supplement can be any substance which is highly palatable to carnivorous animals such as dogs and cats. Generally, it is preferred for the palatability enhancer to be formed primarily of material derived from animals. More preferably, the palatability enhancer is formed primarily of a material selected from the group consisting of meat, blood and mixtures thereof. As used herein, the term “primarily” or “predominately” shall mean more than 50 percent by weight. Most preferably, the palatability enhancer consists essentially of materials derived from animals (e.g., meat, blood, and fat).

The relative quantities of bone meal and palatability enhancer present in the inventive composition can vary depending on the particular application for which the supplement is employed. However, it is preferred for the ingestible supplement to comprise at least about 5 weight percent of the bone meal, more preferably at least about 10 weight percent of the bone meal, and most preferably at least 20 weight percent of the bone meal. It is further preferred for the ingestible supplement to comprise in the range of from about 15 to about 45 weight percent of the bone meal, and most preferably 20 to 30 weight percent of the bone meal. It is preferred for the ingestible supplement to comprise at least about 25 weight percent of the palatability enhancer, more preferably at least about 50 weight percent of the palatability enhancer, and most preferably at least 70 weight percent of the palatability enhancer. It is further preferred for the ingestible supplement to comprise in the range of from about 60 to about 90 weight percent of the palatability enhancer, most preferably from 70 to 80 weight percent of the palatability enhancer. It is preferred for the bone meal and palatability enhancer to be present in the ingestible supplement in a bone meal-to-palatability enhancer weight ratio in the range of from about 1:10 to about 1:1, more preferably in the range of from about 1:5 to about 1:2, still more preferably in the range of from about 1:4 to about 1:2.5, even more preferably in the range of from 1:3.5 to 1:2.75, and most preferably about 1:3.

The inventive ingestible supplement is preferably produced in the form of a capsule that includes an ingestible shell filled with the bone meal and palatability enhancer. The ingestible shell is preferably formed of a biodegradable material that dissolves rapidly after ingestion by an animal. Most preferably, the ingestible shell is formed of a gelatin material. It is preferred for each ingestible supplement capsule to include at least 0.25 ounces of the bone meal, and more preferably at least about 0.5 ounces of the bone meal, still more preferably at least about 0.75 ounces of the bone meal, and most preferably 1 to 4 ounces of the bone meal.

In another embodiment of the present invention, there is provided a method of preventing carnivorous animals from grazing on vegetation. The method generally involves feeding the ingestible bone meal-containing supplement, described above, to the animal. The supplement can be fed to the animal on a regular basis in order to continuously prevent the animal from grazing. Alternatively, the supplement can be administered just prior to an activity (e.g., hunting) during which it is desirable to prevent the animal (e.g., hunting dog) from grazing on vegetation. The frequency and amount of the ingestible supplement that is administered to the carnivorous animal can vary greatly depending upon the size of the animal and the size of the supplement capsule.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as it pertains to any system not materially departing from but outside the literal scope of the invention as set forth in the following claims.

What is claimed is:

1. An ingestible supplement comprising:
at least about 25 weight percent of a palatability enhancer that is highly palatable to carnivorous animals; and
at least about 5 weight percent bone meal,
said bone meal and said palatability enhancer being present in the supplement in a bone meal-to-palatability enhancer weight ratio in the range of from about 1:10 to about 1:1.

2. The supplement according to claim 1,
said palatability enhancer being formed primarily of material derived from animals.

3. The supplement according to claim 1,
said palatability enhancer being formed primarily of a material selected from the group consisting of meat, blood, and mixtures thereof.

4. The supplement according to claim 1; and
an ingestible shell within which the palatability enhancer and the bone meal are received.

5. The supplement according to claim 4,
said shell being formed of a biodegradable material.

6. The supplement according to claim 4,
said shell being formed of a gelatin material.

7. The supplement according to claim 1,
said supplement comprising at least about 50 weight percent of the palatability enhancer and at least about 10 weight percent of the bone meal.

8. The supplement according to claim 7,
said bone meal-to-palatability enhancer weight ratio being in the range from about 1:5 to about 1:2.

9. The supplement according to claim 1,
said supplement comprising at least about 70 weight percent of the palatability enhancer and at least about 20 weight percent of the bone meal.

10. The supplement according to claim 9,
said bone meal-to-palatability enhancer weight ratio being in the range of from about 1:4 to about 1:2.5.

11. The supplement according to claim 1,
said supplement comprising in the range from about 60 to about 80 weight percent of the palatability enhancer and in the range from about 15 to about 40 weight percent of the bone meal.

12. The supplement according to claim 11,
said bone meal-to-palatability enhancer weight ratio being in the range from 1:3.5 to 1:2.75.

13. An ingestible supplement palatable to dogs and cats, said supplement consisting essentially of:
a palatability enhancer that is highly palatable to carnivorous animals; and
bone meal,
said bone meal and said palatability enhancer being present in the supplement in a bone meal-to-palatability enhancer weight ratio in the range of from about 1:5 to about 1:2.

14. The supplement according to claim 13,
said palatability enhancer being formed primarily of material derived from animals.

15. The supplement according to claim 13,
said palatability enhancer being formed primarily of a material selected from the group consisting of meat, blood, and mixtures thereof.

16. The supplement according to claim 13,
said bone meal-to-palatability enhancer weight ratio being in the range of from about 1:4 to about 1:2.5.

17. The supplement according to claim 13,
said bone meal-to-palatability enhancer weight ratio being in the range from 1:3.5 to 1:2.75.

18. The supplement according to claim 13,
said supplement comprising in the range from about 60 to about 80 weight percent of the palatability enhancer and in the range from about 15 to about 40 weight percent of the bone meal.

19. A method of preventing a carnivorous animal from grazing on vegetation, said method comprising the steps of:
(a) causing the animal to ingest a supplement comprising at least about 5 weight percent bone meal and at least about 25 weight percent of a palatability enhancer that is highly palatable to the carnivorous animal.

20. The method according to claim 19,
said palatability enhancer being formed primarily of material derived from animals.

21. The method according to claim 19,
said palatability enhancer being formed primarily of a material selected from the group consisting of meat, blood, and mixtures thereof.

22. The method according to claim 19,
said supplement including an ingestible shell within which the bone meal and palatability enhancer are received.

23. The method according to claim 22,
said supplement consisting essentially of the bone meal, the palatability enhancer, and the ingestible shell.

24. The method according to claim 19,
said supplement comprising the bone meal and the palatability enhancer in a bone meal-to-palatability enhancer weight ratio in the range from about 1:10 to about 1:1.

25. The method according to claim 24,
said supplement comprising at least about 10 weight percent of the bone meal and at least about 50 weight percent of the palatability enhancer.

26. The method according to claim 25,
said bone meal-to-palatability enhancer weight ratio being in the range of from about 1:5 to about 1:2.

27. The method according to claim 26,
said supplement comprising in the range of from about 15 to about 40 weight percent of the bone meal and in the range of from about 60 to about 80 weight percent of the palatability enhancer.

28. The method according to claim 19,
said supplement consisting essentially of the bone meal and the palatability enhancer.
